(19) United States
(12) Patent Application Publication
(10) Pub. No.: US 2018/0174261 A1
(43) Pub. Date: Jun. 21, 2018

(54) SYSTEMS, DEVICES, & METHODS FOR LOCATING OPIOID ANTAGONIST PRODUCTS

(71) Applicant: Adapt Pharma Operations Limited, Dublin (IE)

(72) Inventor: David Brabazon, Dublin (IE)

(21) Appl. No.: 15/846,436

(22) Filed: Dec. 19, 2017

Related U.S. Application Data
(60) Provisional application No. 62/436,914, filed on Dec. 20, 2016.

(51) Int. Cl. G06Q 50/26; G01S 19/46

(52) U.S. Cl. CPC G06Q 50/265; H04B 1/3833; G01S 19/46

(57) ABSTRACT

The present disclosure relates to systems, devices and methods for locating opioid antagonist products associated with an opioid related condition. According to one aspect, a mobile computing device for locating an opioid antagonist product generally includes one or more processors, memory, a display, a user interface, a global positioning system (GPS) antenna, and a wireless communication antenna. The one or more processors are configured to determine a location of the mobile computing device based on a global positioning system signal, receive an input from a user indicative of an opioid related condition and, in response to receiving the input, communicate with one or more wireless networks to determine a location of one or more opioid antagonist products located near the mobile computing device. The one or more processors are configured to display the determined location(s) of the opioid antagonist product(s) located near the mobile computing device on the display.

### CROSS-REFERENCE TO RELATED APPLICATION

This application claims the benefit and priority of U.S. Provisional Application No. 62/436,914, filed on Dec. 20, 2016. The entire disclosure of the above application is incorporated herein by reference

### FIELD

The present disclosure generally relates to systems, devices and methods for locating opioid antagonist products.

### BACKGROUND

This section provides background information related to the present disclosure which is not necessarily prior art.

Individuals may experience opioid related conditions for which treatment is needed quickly. For example, some individuals may experience opioid overdose emergencies for which pharmaceutical treatment is needed in a short period of time (e.g., before death or serious injury resulting from drug overdose can occur) to treat the opioid related condition. Some products exist to quickly treat opioid related conditions, such as nasal spray products designed to deliver opioid treatment medication to the individual experiencing the opioid related condition.

### SUMMARY

This section provides a general summary of the disclosure, and is not a comprehensive disclosure of its full scope or all of its features.

According to one aspect of the present disclosure, a mobile computing device for locating a nasal spray product generally includes one or more processors, memory coupled to the one or more processors and configured to store computer-executable instructions, a device display coupled to the one or more processors and configured to display information to a user, a user interface coupled to the one or more processors and configured to receive input from the user, a global positioning system (GPS) antenna coupled to the one or more processors and configured to receive a GPS signal to determine a location of the mobile computing device, and a wireless communication antenna coupled to the one or more processors and configured for wireless communication via one or more wireless networks.

As used herein, a “GPS” includes any device capable of locating and transmitting a device location. The one or more processors are configured to execute the computer-executable instructions to determine a location of the mobile computing device based on the GPS signal received by the GPS antenna, to receive an input from a user indicative of an opioid related condition, and in response to receiving the input indicative of the opioid related condition (for example, an opioid related emergency such as opioid induced respiratory depression), to communicate with the one or more wireless networks via the wireless communication antenna to determine a location of one or more nasal spray products located near the mobile computing device. The one or more processors may also be configured to display, via the device display, the determined location(s) of the one or more nasal spray products located near the mobile computing device.

According to another aspect of the present disclosure, a system for transmitting an opioid related condition alert to a communication device associated with opioid antagonist products generally includes one or more communication devices. Each communication device is associated with a user having access or needing access to an opioid antagonist product. The system also includes a mobile computing device comprising a one or more processors, memory coupled to the processor and configured to store computer-executable instructions, a display, a user interface, a global positioning satellite (GPS) antenna, and a wireless communication antenna. The one or more processors are configured to execute the computer-executable instructions to cause the one or more processors to determine a location of the mobile computing device based on a GPS signal received by the GPS antenna, to receive an input from a user indicative of an opioid related condition, and in response to receiving the input indicative of the opioid related condition, to communicate with one or more wireless networks via the wireless communication antenna to determine nearby ones of the one or more communication devices associated with users having access to nasal spray products. The one or more processors are also configured to transmit the opioid related condition alert to the determined nearby ones of the multiple communication devices, thereby allowing nearby persons having access to opioid antagonist products to respond to the opioid related condition (e.g., the opioid related emergency condition).

According to yet another aspect of the present disclosure, a computer-implemented method for locating a nasal spray product using a mobile computing device is disclosed. The mobile computing device includes one or more processors, memory, a display, a user interface, a global positioning system (GPS) antenna, and a wireless communication antenna. The method includes determining a location of the computing device based on a GPS signal received by the GPS antenna, receiving, via the user interface, an input from a user indicative of an opioid related condition, and in response to receiving the input indicative of the opioid related condition, communicating with one or more wireless networks via the wireless communication antenna to determine nearby nasal spray products. The method also includes displaying, via the device display, location(s) of the determined nearby nasal spray products, or transmitting an opioid related condition alert to a communication device associated with a user having access to the determined nearby nasal spray products.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a mobile computing device for locating nearby nasal spray products associated with treating an opioid related condition, according to one example embodiment of the present disclosure.

FIG. 2 is a diagram of an example system including the mobile computing device of FIG. 1 in communication with entities associated with the nasal spray products.

FIG. 3 is a diagram of another example system including the mobile computing device of FIG. 1 in communication with multiple communication devices potentially available to respond to the opioid related condition.

FIG. 4 is a flow chart of a method for locating nearby nasal spray products according to another example embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “opioid related condition,” as used herein, refers to a medical condition induced by use of one or more opioids. In some embodiments, the opioid related condition is an acute medical condition induced by excessive use of one or more opioids, also known as an opioid “overdose.” Symptoms of opioid overdose include including respiratory depression, central nervous system depression (which may include sedation, altered level consciousness, and constricted pupils), and cardiovascular depression (which may include hypoxemia and hypotension). Visible signs of an opioid related condition include: unresponsiveness and/or loss of consciousness (unresponsiveness to stimuli such as shouting, shaking, or rubbing knuckles on sternum); slow, erratic, or stopped breathing; slow, erratic, or stopped pulse; deep snoring or choking/gurgling sounds; blue or purple fingernails or lips; pale and/or clammy face; slack or limp muscle tone; contracted pupils; and vomiting. Because opioid overdose may be difficult to diagnose and/or quantify, particularly by a lay person, as used herein, treatment of opioid related conditions is meant to include treatment of suspected opioid overdose in opioid-intoxicated patients. Opioids that may induce overdose include codeine, morphine, methadone, fentanyl and fentanyl-derivatives such as carfentanyl, oxycodone HCl, hydrocodone bitartrate, hydromorphone, oxymorphone, meperidine, propoxyphene, opium, heroin, tramadol, tapentadol, and certain narcotic-antagonist analgesics, such as, nalbuphine, pentazocine and butorphanol.

Some embodiments of the present disclosure include computing devices, mobile devices, computer-executable applications, modules, etc. that can be used, in whole or part, to facilitate a computing device locating pharmaceutical products for treating opioid related conditions. Some pharmaceutical products (e.g., nasal spray products, etc.) may be used to quickly treat opioid overdose emergencies in a short period of time. For example, individuals experiencing an opioid overdose may require treatment sooner than would normally be provided though making a trip to the hospital, etc. Example embodiments of the present disclosure may provide applications (e.g., for mobile computing devices, etc.) designed to allow a user to send out an opioid related condition alert, to respond to an opioid related condition alert, to identify nearby pharmacies, hospitals, police and fire stations, and other locations having products for treating opioid related conditions.

These computer-executable applications may assist users in obtaining treatment for opioid overdoses, etc. in a faster manner than would otherwise be available. Specifically, existing mobile computing devices are not able to determine locations of nearby products for treating opioid related conditions. Example embodiments described herein overcome this technical problem by improving the functionality of mobile computing devices to facilitate locating nearby pharmaceutical products for treating opioid related conditions. In some cases, technical functionality of the mobile computing device may be improved by increasing the communication capabilities of the mobile computing device, increasing the amount of information available to the mobile computing device, creating a new network of linked mobile computing devices (e.g., each associated with a location of a pharmaceutical product for treating opioid related conditions), etc.

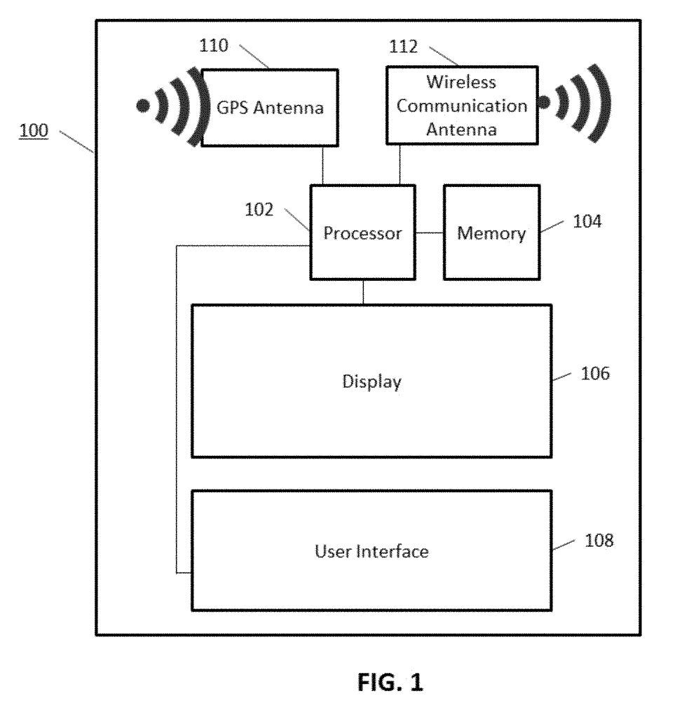

One example embodiment of a mobile computing device 100 for locating a nasal spray product is illustrated in FIG. 1. As shown in FIG. 1, the mobile computing device 100 includes a processor 102 and memory 104 coupled to the processor 102. The memory 104 is configured to store computer-executable instructions. The processor 102 is configured to read the computer-executable instructions from memory 104 and to execute the computer-executable instructions to perform one or more functions.

The device 100 may include any suitable mobile computing device. For example, the device 100 may include a cellular phone (e.g., smartphones, etc.), a tablet computer, a laptop computer, etc.

The processor 102 may be any suitable processor, including a central processing unit, microcontroller, microprocessor, integrated circuit, etc. The processor 102 may be configured to execute any suitable computer-executable instructions, including machine language code, assembly language code, java code, C++ code, etc. In operation, the processor 102 may execute the processor-executable instructions (e.g., using software, firmware, and/or hardware) to implement aspects of the present disclosure as described herein. Although only a single processor 102 is illustrated in FIG. 1, it should be apparent that other embodiments may include more than one processor configured to implement aspects of the disclosure as described herein.

The memory 104 may be any suitable memory for storing computer-executable instructions, information, data, etc. For example, the memory 104 may include one or more hard drives, flash drives, random access memory, etc.

The device 100 also includes a device display 106 coupled to the processor 102, and a user interface 108 coupled to the processor 102. The display 106 is configured to display information to a user. The user interface 108 is configured to receive input from the user.

The display 106 may be any suitable display for displaying information to a user, including a display screen, a touchscreen, etc. For example, the display screen may be a display screen of a mobile phone, etc. The user interface 108 may include a keypad, keyboard, touchscreen, etc. In some embodiments, the user interface 108 may be the same as the display 106, different from the display 106, etc. For example, the user interface 108 may be a touchscreen of a mobile phone.

The device 100 further includes a global positioning system (GPS) antenna 110 coupled to the processor 102. The GPS antenna 110 is configured to receive a GPS signal to determine a location of the device 100. The GPS antenna may be any suitable GPS antenna including a GPS receiving element, GPS transmitter, GPS transceiver, etc. The GPS antenna 110 may be configured to receive the GPS signal for determining location from any satellite based location service, including GPS, GNSS, GLONASS, GALILEO, etc.

The device 100 further includes a wireless communication antenna 112 coupled to the processor 102. The wireless communication antenna 112 is configured to communicate wirelessly via one or more wireless networks. The wireless communication antenna 112 may be any suitable antenna element capable of communicating with a wireless network, including a wireless receiver, wireless transmitter, wireless transceiver, etc. The wireless communication antenna 112 may communicate with one or more of any suitable wireless networks, including cellular networks (e.g., 3G, 4G, LTE, etc.), WiFi networks (e.g., 802.11, etc.), local area networks, the Internet, BLUETOOTH, etc. The wireless communication antenna 112 may operate at any suitable frequency, such as 2.4 GHz, 5.0 GHz, etc.

The processor 102 may be configured to determine a location of the device 100 based on a GPS signal received by the GPS antenna 110. For example, the GPS antenna 110 may receive one or more GPS signals from GPS satellite(s) and the processor may determine a location of the device 100 based on the received GPS signal(s) (e.g., based on relative timestamps of respective GPS signals, etc.).

The processor 102 may be configured to receive an input from a user indicative of an opioid related condition. For example, a user may indicate an opioid related condition through the user interface 108 by pressing a button, selecting an icon illustrated on the display 106, etc.

In response to receiving the input indicative of the opioid related condition, the processor 102 may be configured to communicate with one or more wireless networks via the wireless communication antenna 112 to determine a location of one or more nasal spray products (e.g., designed to treat the opioid related condition) located near the device 100.

The determined nearby nasal spray products may be based on locations of nearby pharmacies and hospitals having the nasal spray products, nearby dispensers having nasal spray products, nearby responder personnel having nasal spray products, etc. The device 100 may communicate via the one or more wireless networks (e.g., cellular, WiFi, etc.) with a server, etc. to determine locations of nearby nasal spray products based on the location of device 100. For example, the server may store information regarding pharmacies, dispensers, emergency responders, etc. having access to the nasal spray products, and the locations of these pharmacies, dispensers, responders, etc.

The processor 102 may then display the determined location(s) of the nearby nasal spray products on the display 106 of device 100. For example, the processor 102 may display locations of the nearby pharmacies carrying the nasal spray products on a screen of the device 100, may display locations of nearby emergency responders (e.g., hospitals, ambulances, fire stations, police stations, etc.), may display locations of nasal spray product dispensers, etc. Therefore, the mobile computing device 100 provides improved technical capabilities that are not available on conventional generic mobile devices.

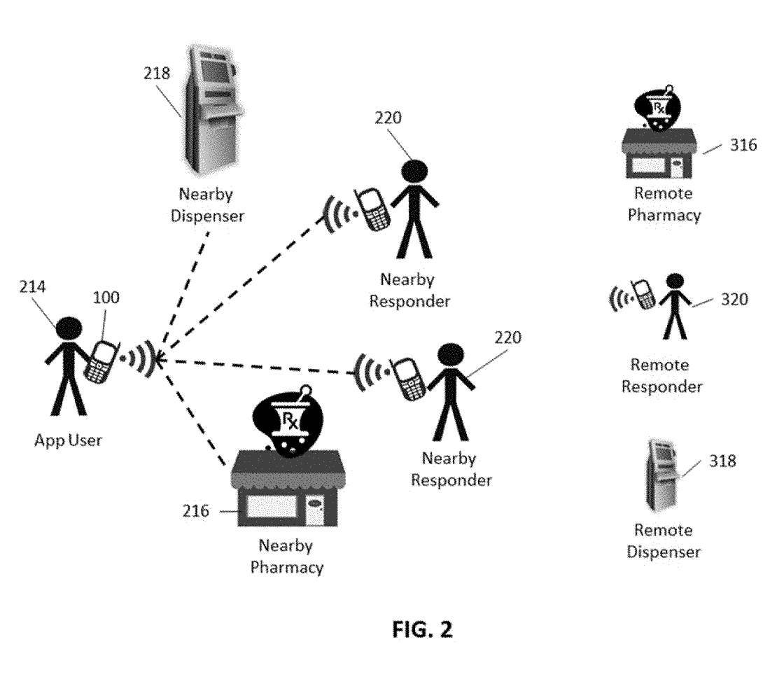

An example of the above process is illustrated in FIG. 2. As shown in FIG. 2, after a user 214 indicates an opioid related condition to device 100, the device 100 determines locations of nearby nasal spray products designed for treatment of the opioid related condition.

For example, the device 100 determines (e.g., using a wireless communication antenna of the device 100 to communicate with a remote server, etc.) a nearby pharmacy 216 that carries the nasal spray products for treating the opioid related condition that is closer to the device 100, but another remote pharmacy 316 that carries the nasal spray products is located further from the device 100. Accordingly, the device 100 may display the location of the nearby pharmacy 216, but not display the location of the remote pharmacy 316.

The device 100 may use any suitable criteria for determining what nasal spray product locations are ‘nearby’ the device, including but not limited to a closest number of locations, a threshold distance from the device 100, a threshold amount of time to travel from the location of device 100. For example, the device 100 may display only the closest pharmacy, the closest two pharmacies, the closest three pharmacies, etc. that carry the nasal spray product, regardless of distance. The device 100 may display all pharmacies within one mile, five, miles, ten miles, etc. that carry the nasal spray product. The device 100 may display all pharmacies that can be driven to within one minute, five minutes, ten minutes, etc. that carry the nasal spray product. As should be apparent, other thresholds for determining which ‘nearby’ product locations to display may be used in other embodiments.

Referring again to FIG. 2, the device 100 may determine (e.g., using a wireless communication antenna of the device 100 to communicate with a remote server, etc.) a nearby dispenser 218 that carries the nasal spray products for treating the opioid related condition that is closer to the device 100, but another remote dispenser 318 that carries the nasal spray products is located further from the device 100. Accordingly, the device 100 may display the location of the nearby dispenser 316, but not display the location of the remote dispenser 318. As described above, any suitable threshold may be used to determine which dispensers are nearby the device 100 and which dispensers are remote from the device 100.

The device 100 may also determine (e.g., using a wireless communication antenna of the device 100 to communicate with a remote server, etc.) nearby emergency responders 220 that carry the nasal spray products for treating the opioid related condition that are closer to the device 100, but other remote emergency responders 320 that carry the nasal spray products are located further from the device 100. Accordingly, the device 100 may display the location of the nearby emergency responders 220, but not display the location of the remote emergency responders 320. As described above, any suitable threshold may be used to determine which emergency responders are nearby the device 100 and which emergency responders are remote from the device 100.

In some embodiments, the criteria thresholds for determining nearby product locations to be displayed may vary based on the type of entity carrying the product. For example, only pharmacies within five miles may be displayed as nearby the device 100, while emergency responders within ten miles of the device may be displayed as nearby the device 100 if the emergency responders can get to the location of the device 100 faster than the user of the device 100 could get to a pharmacy and back to a patient experiencing the opioid related condition, or get the patient experiencing the opioid related condition to the pharmacy.

When displaying closest pharmacy locations, the processor 102 may be configured to also display information regarding whether the pharmacy 216 has a current supply of the product in the store, whether a prescription is needed to obtain the product, etc. For example, many states and many pharmacy chains have standing orders or statewide prescriptions for the opioid related treatment products such that a prescription for the products is not needed.

As describe above, the processor 102 may be configured to display location of nearby dispenser devices 218 (e.g., on the display screen of the mobile computing device 100). Each dispenser device 218 may be associated with a dispenser of devices, kits, and pharmaceutical solutions (“product”) as disclosed herein. Each dispenser device 218 is located at a dispenser location and can store dispenser information including dispenser location data, product availability data, and whether the dispenser is or is not presently in service. A server may be in communication with the device 100 and/or a plurality of dispenser devices 218 and may be configured to receive a patient request for information about availability and location of product from the device 100, to receive the dispenser information from each of the dispenser devices 218, to apply a selection criteria to the received dispenser information, to determine at least one potential dispenser 218 located proximal to the patient location and in service at the time of request, to communicate the dispenser information for the at least one potential dispenser 218 to the device 100, etc.

The device 100 may be configured to receive the dispenser information for the at least one potential dispenser 218 from the server, and to display the dispenser information for the at least one potential dispenser 218. In certain embodiments, the server may also be configured to receive a signal from the patient indicating that the patient intends to retrieve product from at least one of the indicated dispensers 218 and to notify the dispenser device 218 that someone is coming to retrieve product from the dispenser 218.

In some embodiments, the processor 102 may be configured to display additional information such as a nearest hospital, nearest first responder (e.g., emergency responder personnel, ambulances, firefighter personnel, police officer personnel, etc.) locations, etc. For example, the processor 102 may control the display 106 to display the additional information on a screen of the display. The processor 102 may be configured to display phone numbers for contacting nearby hospitals, ambulances, emergency responders, fire stations, police stations, etc.

The processor 102 may display information regarding correct usage of the products to treat the opioid related condition. For example, the processor 102 may show a video on the display 106 illustrating how to administer the product to treat the opioid related condition. The video may talk a person through the steps of administering the product to a patient. The application may include information on administering the product related to the label, a quick start guide, etc.

In some embodiments, the processor 102 may communicate through the wireless communication antenna 112 to a remote assistance provider to help a user locate, administer, etc. the opioid treatment product. For example, the device 100 may establish a voice communication channel, phone call, etc. through a cellular network, a WiFi network, etc. to a remote assistance provider. The remote assistance provider may talk to a person wishing to administer naloxone or another suitable opioid antagonist to a patient about how to locate the opioid assistance product, how to administer the opioid assistance product, etc. This may be similar to a medic talking a patient, family member, responder, etc. through the process of giving an unconscious person a nasal spray product treatment, what steps to take next (e.g., calling an ambulance, administering CPR, etc.), etc. Communication with the remote assistance provider over the voice communication channel may be performed in addition to, or as an alternative to, communication with a server to determine location of nearby products for treating opioid related conditions.

The applications described herein may be useful to first responders, such that the first responders can use the applications to locate nasal spray products for treating opioid related conditions, if the first responders arrive to treat a patient experiencing an opioid related condition.

The product for treating the opioid related condition may be any suitable product (e.g., pharmaceutical product) capable of being administered to a patient experiencing the opioid related condition to treat the opioid related condition. For example, the product could include a product for treating an opioid overdose in the patient. The opioid related condition may include an opioid induced respiratory depression. The opioid related condition may be an emergency in which treatment is needed in a short amount of time (e.g., less than one minute, less than five minutes, less than ten minutes, etc.) to reduce the possibility of further injury, death, etc. of the patient. For example, an emergency opioid overdose may require treatment more quickly than the time required to travel to a hospital, etc. to receive treatment.

In some embodiments, the product may be a nasal spray product, an injectable product, a tablet product, etc. The product can include an opioid antagonist such as naloxone, naltrexone, methylnaltrexone, or nalmefene, or a pharmaceutically acceptable salt thereof. In some embodiments, the opioid antagonist is naloxone hydrochloride. In some embodiments, the opioid antagonist is naloxone hydrochloride dihydrate. In some embodiments, the opioid antagonist is naltrexone hydrochloride. In some embodiments, the opioid antagonist is methylnaltrexone bromide. In some embodiments, the opioid antagonist is nalmefene hydrochloride. In some embodiments, the nasally administering is accomplished using a device described herein.

The nasal spray product comprising an opioid antagonist can further comprise one or more ingredients selected from an isotonicity agent, a stabilizing agent, and an amount of acid sufficient to adjust pH to 3.5-5.5. The product may include a compound that is one of at least a preservative, a cationic surfactant, a permeation enhancer, etc.

In some embodiments, naloxone is present in the product at an amount equivalent to about 4 mg to about 50 mg of naloxone hydrochloride. In some embodiments, the amount is equivalent to an amount chosen from about 2 mg naloxone hydrochloride, about 4 mg naloxone hydrochloride, about 8 mg naloxone hydrochloride, about 10 mg naloxone hydrochloride, about 12 mg naloxone hydrochloride, about 14 mg naloxone hydrochloride, or about 16 mg naloxone hydrochloride. In some embodiments, the amount is equivalent to about 2 mg of naloxone hydrochloride. In some embodiments, the amount is equivalent to about 4 mg of naloxone hydrochloride. In some embodiments, the amount is equivalent to about 8 mg of naloxone hydrochloride. In some embodiments, the amount is equivalent to about 3.4 mg of naloxone hydrochloride. In various embodiments, the product is capable of multi-dose administration. For example, the product can be a combination of two or more naloxone products (e.g., multi-devices packaged together as a single unit for distribution) or a multi-dose device capable of two or more administrations. Each dose of the multi-dose administration can be of any amount described herein, e.g., 2 mg, 4 mg, 8 mg, etc. None limiting examples of the multi-dose administration include 2×2 mg, 2×4 mg, 2×8 mg, 2 mg+4 mg, 2 mg+8 mg, 4 mg+8 mg, 2×2 mg & 1×4 mg, and 2×4 mg & 1×2 mg.

In some embodiments, naloxone or naloxone hydrochloride is the only pharmaceutically active compound in the product.

In some embodiments, the naloxone HCl is dissolved in aqueous solution as a pharmaceutical composition, loaded in a reservoir of a nasal spray device. In some embodiments, the volume of pharmaceutical composition in said reservoir is not more than about 140 μL, for example 125 μL. In some embodiments, about 100 μL of said pharmaceutical composition in said reservoir is delivered to said patient in one actuation of the nasal spray device.

In some embodiments, the naloxone or naloxone HCl is loaded into a spray device as a dry powder. In some embodiments, the naloxone or naloxone HCl is combined with other pharmaceutically active ingredients.

In some embodiments, said pharmaceutical composition is substantially free of antimicrobial preservatives.

In some embodiments, said pharmaceutical composition further comprises one or more excipients selected from water and NaCl. In some embodiments, said pharmaceutical composition further comprises a preservative, permeation/penetration enhancer and/or a cationic surfactant; an isotonicity agent; a stabilizing agent; and an amount of acid sufficient to achieve a pH of 3.5-5.5. In some embodiments, the preservative, permeation/penetration enhancer and/or a cationic surfactant is selected from quaternary ammonium compounds (e.g., benzalkonium chloride), cyclodextrins, fusidic acid derivatives, phosphatidylcholines, microspheres and liposomes, and bile salts. In a particular embodiment, the preservative, permeation/penetration enhancer and/or a cationic surfactant is benzalkonium chloride.

In some embodiments, said pharmaceutical composition further comprises one or more excipients selected from water, NaCl, benzalkonium chloride, sodium edetate, disodium edetate, and hydrochloric acid. In some embodiments, said pharmaceutical composition further comprises water, NaCl, benzalkonium chloride, disodium edetate, and hydrochloric acid.

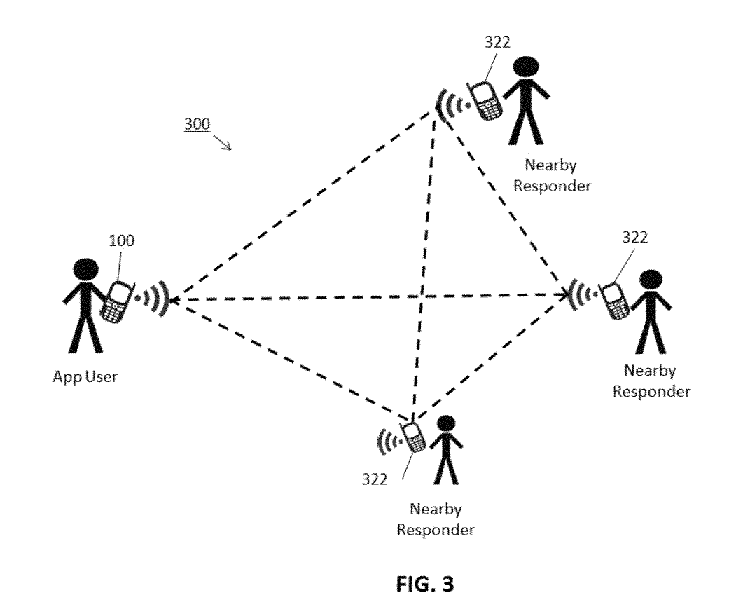

In another example embodiment illustrated in FIG. 3, a system 300 for transmitting an opioid related condition alert to a communication device associated with nasal spray products includes one or more communication devices 322. Each communication device 322 is associated with a user having access to a nasal spray product.

The system 300 also includes a mobile computing device 100 comprising a processor 102, memory 104 coupled to the processor 102 and configured to store computer-executable instructions, a display 106, a user interface 108, a global positioning satellite (GPS) antenna 110, and a wireless communication antenna 112.

The device 100 may be configured to determine a location of the device 100 based on a GPS signal received by the GPS antenna 110, and to receive an input from a user indicative of an opioid related condition (e.g., via a user interface of the device 100). In response to receiving the input indicative of the opioid related condition, the device 100 may be configured to communicate with one or more wireless networks via the wireless communication antenna 112 to determine nearby ones of the one or more communication devices 322 associated with users having access to nasal spray products. For example, the device 100 may use a wireless communication antenna of the device 100 to communicate with the one or more communication device 322, with a remote server that is in communication with the one or more communication devices 322, etc.

The device 100 may be configured to transmit the opioid related condition alert to the determined nearby ones of the multiple communication devices 322, thereby allowing the alerted nearby users to respond to the opioid related condition. For example, the message may be transmitted from the device 100 to the communication devices 322 via the Internet (e.g., a remote server), via a direct text messaging service, etc.

Accordingly, some individuals (e.g., concerned members of the community, persons familiar with opioid related conditions, responder personnel such as fire, police, or medics, etc.) may carry nasal spray products (or other opioid antagonist products) around with them on a daily basis, etc. The individuals may also have communication devices 322 that are configured to receive alerts when another person is having an opioid related condition. The individuals can then choose to respond, based on the location of the individuals having the communication devices 322 and the location of the patient experiencing the opioid related condition.

For example, when a user indicates an opioid related condition to the device 100, the device 100 can determine nearby communication devices 322 associated with access to nasal spray products (or other opioid antagonist products) for treatment of opioid related conditions. The device 100 can transmit the alert and the location of the device 100 associated with the opioid related condition to each of the communication devices 322.

Each of the communication devices 322 may be configured to, upon receiving the opioid overdose condition alert from the device 100, display a location of the device 100 (e.g., on a display screen of the device 322). This can allow the user associated with the communication device 322 to determine if said user is available to assist with the opioid related condition.

For example, a user may be notified, on their communication device 322, of the opioid condition alert that is currently happening at the location of device 100. The user can then determine if they are available to assist in the opioid related condition (e.g., by bringing the nasal spray product to the patient to treat the opioid related condition, etc.).

The user of the communication device 322 may provide an input to the device 322 to indicate they are available to assist. The communication device 322 may then send a notification to the device 100 indicating the responder is available to assist. In some embodiments, the device 100 may display a location of the communication device 322 that indicated assistance was available, an estimated time of arrival based on a distance between the device 100 and the commination device 322, etc.

The communication devices 322 may be any suitable devices capable of communicating via wireless networks, including but not limited to cellular phones, tablet computers, laptop computers, etc. For example, the communication device may be a cellular phone carried by a potential responder.

In some embodiments, the device 100 may show the location of determined nearby communication devices 322 before an assistance indication is received from the communication device 322. However, to protect privacy some embodiments may only show location(s) of communication devices 322 that have responded with an indication they are available to help. For example, the user of communication device 322 may be contacted with an alert if they are nearby device 100 associated with an opioid related condition, but the location of device 322 may not be shown on the display 106 of device 100 unless the user of device 322 indicates they are willing to respond to the alert.

The communication devices 322 may communicate with one another. For example, once a communication device 322 indicates it will assist with the opioid related condition, alerts to other communication devices 322 may be stopped, notifications may be sent to other communications devices 322 that a responder has been found, etc. In some embodiments, notifications may only be sent out after at least two response indications have been received, only after three response indications have been received, etc. to increase the availability of assistance. Additionally, or alternatively, notifications may only be sent out to communication devices 322 that are further from the device 100 than the responding device 322. This may allow potential responders who are closer to the opioid related condition to respond more quickly, even if a further responder has indicated they are available to assist. Notifications may be sent between communication devices 322 using any suitable protocol, such as over the Internet through a remote server, via direct text messaging, etc.

Therefore, the system 300 creates a network of communication devices 322 that provides improved technical performance of the devices 322, by adding technical functionality that is not available on conventional generic mobile computing devices. For example, the devices 322 are able to communicate with one another in manners not previously performed by conventional generic mobile computing devices, the devices 322 are able to obtain and display information not previously performed by conventional generic mobile computing devices, etc.

According to another example embodiment, a computer-implemented method of for locating a nasal spray or an opioid antagonist product using a mobile computing device is disclosed. The mobile computing device includes one or more processors, memory, a display, a user interface, a global positioning system (GPS) antenna, and a wireless communication antenna.

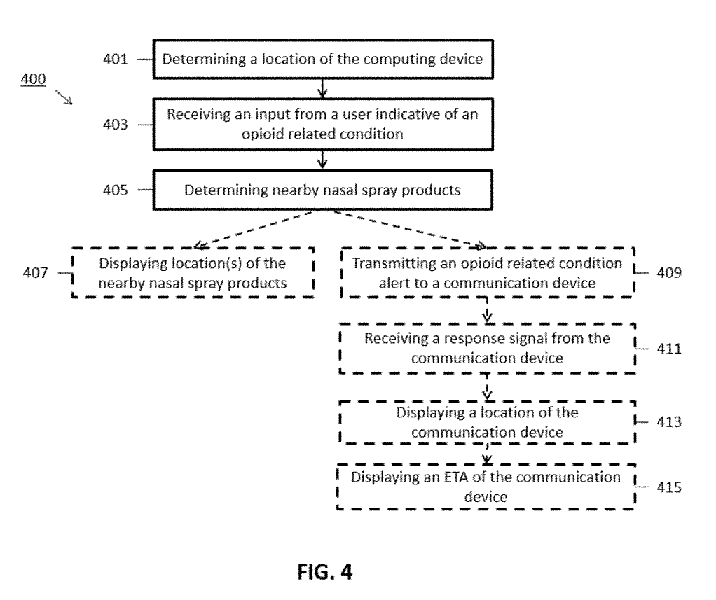

The example method 400 is illustrated generally in FIG. 4. As shown, at 401 the method includes determining a location of the computing device based on a GPS signal received by the GPS antenna. The location of the computing device may be determined using any suitable method based on the GPS signal received by the GPS antenna, including examples described herein

At 403, the method includes receiving, via the user interface, an input from a user indicative of an opioid related condition. As described above, the user may indicate an opioid related condition through any suitable, icon, button, key, input, etc. of the user interface of the device.

At 405, the method includes, in response to receiving the input indicative of the opioid related condition, communicating with one or more wireless networks via the wireless communication antenna to determine nearby opioid antagonist products or nasal spray products. As described herein, the processor may communicate via cellular networks, WiFi networks, etc., to determine the location of nearby pharmacies, dispensers, responder personnel, communication devices associated with users having access to nasal spray products.

After the nearby opioid antagonist products or nasal spray products are determined, the method includes optionally displaying, at 407, via the device display, location(s) of the determined nearby opioid antagonist products or nasal spray products.

Alternatively, or in addition, the method includes optionally transmitting, at 409, an opioid related condition alert to a communication device associated with a user having access to the determined nearby opioid antagonist products or nasal spray products. In this case, the method may include, at 411, receiving a response signal from at least one of the determined nearby ones of the multiple communication devices. The response signal is indicative of availability of the user associated with said at least one determined nearby communication device to assist with the opioid related condition.

The method 400 may further include, at 413, displaying a location of the communication device from which the response signal was received. At 415, the method may optionally include displaying an estimated time of arrival of the communication device from which the response signal was received, based on a location of the communication device from which the response signal was received.

Accordingly, the computer-implemented method may allow a user to determine locations of nearby opioid antagonist products or nasal spray products to that a user can go obtain the opioid antagonist products, and/or the method may allow a user to transmit an alert to nearby responders to the nearby responders can bring the opioid antagonist product to the patient for treatment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mobile computing device configured to locate an opioid antagonist product, the device comprising:
one or more processors;
memory coupled to the one or more processors and configured to store computer-executable instructions;
a device display coupled to the one or more processors and configured to display information to a user;
a user interface coupled to the one or more processors and configured to receive input from the user;
a global positioning system (GPS) antenna coupled to the one or more processors and configured to receive a GPS signal to determine a location of the mobile computing device; and
a wireless communication antenna coupled to the one or more processors and configured for wireless communication via one or more wireless networks;
wherein the one or more processors are configured to execute the computer-executable instructions to:
determine a location of the mobile computing device based on the GPS signal received by the GPS antenna;
receive an input from a user indicative of an opioid related condition;
in response to receiving the input indicative of the opioid related condition, communicate with the one or more wireless networks via the wireless communication antenna to determine a location of one or more nasal spray products located near the mobile computing device; and
display, via the device display, the determined location(s) of the one or more nasal spray products located near the mobile computing device.

2. The device of claim 1, wherein the device comprises one of a mobile phone and a tablet computer.

3. The device of claim 1, wherein the opioid antagonist product comprises a pharmaceutical product for treating an opioid overdose in a patient.

4. The device of claim 3, wherein the opioid antagonist product comprises naloxone hydrochloride or a hydrate thereof.

5. The device of claim 4, wherein the opioid antagonist product is a nasal spray product comprising an isotonicity agent, a stabilizing agent, an amount of acid sufficient to adjust pH to 3.5-5.5, and a compound that is at least one of a preservative, a cationic surfactant, and a permeation enhancer.

6. The device of claim 1, wherein the one or more processors are configured to execute the computer-executable instructions to: in response to receiving the input indicative of the opioid related condition, communicate with the one or more wireless networks via the wireless communication antenna to determine a location of one or more other products associated with treating the opioid related condition and located near the mobile computing device and associated with treating the opioid related condition.

7. The device of claim 6, wherein the one or more other products include one or more injectable products and/or tablet products associated with treating the opioid related condition.

8. The device of claim 1, wherein the opioid related condition is opioid induced respiratory depression.

9. The device of claim 1, wherein:
determining the location of one or more opioid antagonist products located near the mobile computing device includes searching for one or more closest pharmacies stocking the opioid antagonist products; and
displaying includes displaying the determined location(s) of the searched for one or more closest pharmacies stocking the opioid antagonist products.

10. The device of claim 9, wherein displaying includes displaying information regarding whether a prescription is needed in the determined location(s) to obtain the opioid antagonist products.

11. The device of claim 1, wherein:
determining the location of one or more opioid antagonist products located near the mobile computing device includes searching for one or more closest dispenser devices for dispensing the opioid antagonist products; and
displaying includes displaying the determined location(s) of the searched for one or more nearby dispenser devices for dispensing the opioid antagonist products.

12. The device of claim 1, wherein:
determining the location of one or more opioid antagonist products located near the mobile computing device includes searching for one or more closest responder personnel associated with having access to the opioid antagonist products; and
displaying includes displaying the determined location(s) of the searched for one or more nearby responder personnel associated with having access to the opioid antagonist products.

13. The device of claim 12, wherein displaying includes displaying at least one of a location of a nearest hospital and a phone number for the one or more nearby responder personnel.

14. The device of claim 12, wherein the one or more responder personnel include at least one of police station responder personnel, fire station responder personnel, hospital responder personnel, and emergency ambulance responder personnel.

15. The device of claim 1, wherein determining the location of one or more opioid antagonist products located near the mobile computing device includes contacting a server to obtain information regarding the closest opioid antagonist product locations to the user, the server configured to store and periodically update opioid antagonist product location information for pharmacies, dispensers, and/or responder personnel associated with the opioid antagonist products.

16. The device of claim 1, wherein displaying includes displaying usage information including instructions for correct usage of the opioid antagonist product to treat the opioid related condition.

17. The device of claim 16, wherein the usage information includes an instructional video describing how to administer the opioid antagonist product to treat the opioid related condition.

18. The device of claim 1, wherein the one or more processors are configured to execute the computer-executable instructions to communicate with the one or more wireless networks via the wireless communication antenna to link the user with a remote assistance provider though a voice communication channel, thereby allowing the remote assistance provider to provide instruction to the user about administering the opioid antagonist product to treat the opioid related condition.

19. The device of claim 1, wherein the user is an emergency responder personnel.

20. A system for transmitting an opioid related condition alert to a communication device associated with opioid antagonist products, the system comprising:
one or more communication devices, each communication device associated with a user having access to a opioid antagonist product; and
a mobile computing device comprising one or more processors, memory coupled to the one or more processors and configured to store computer-executable instructions, a display, a user interface, a global positioning satellite (GPS) antenna, and a wireless communication antenna;
wherein the one or more processors are configured to execute the computer-executable instructions to:
determine a location of the mobile computing device based on a GPS signal received by the GPS antenna;
receive an input from a user indicative of an opioid related condition;
in response to receiving the input indicative of the opioid related condition, communicate with one or more wireless networks via the wireless communication antenna to determine nearby ones of the one or more communication devices associated with users having access to opioid antagonist products; and
transmit the opioid related condition alert to the determined nearby ones of the multiple communication devices, thereby allowing the alerted nearby users to respond to the opioid related condition.

21. The system of claim 20, wherein the one or more processors are configured to execute the computer-executable instructions to receive a response signal from at least one of the determined nearby ones of the multiple communication devices, the response signal indicative of availability of the user associated with said at least one determined nearby communication device to assist with the opioid related condition.

22. The system of claim 21, wherein the one or more processors are configured to execute the computer-executable instructions to display a location of the communication device from which the response signal was received.

23. The system of claim 21, wherein the one or more processors are configured to execute the computer-executable instructions to cause the one or more processors to display an estimated time of arrival of the communication device from which the response signal was received, based on a location of the communication device from which the response signal was received.

24. The system of claim 20, wherein each of the communication devices are configured to, upon receiving the opioid overdose condition alert from the mobile computing device, display a location of the mobile computing device, thereby allowing the user associated with said communication device to determine if said user is available to assist with the opioid related condition.

25. The system of claim 20, wherein each of the communication devices are configured to:
upon receiving the opioid overdose condition alert from the mobile computing device, receive an input from the user associated with the communication device indicative of whether the user associated with the communication device is available to assist with the opioid related condition; and
when the user associated with the communication device indicates said user is available to assist with the opioid related condition, to transmit a response signal to the mobile computing device.

26. The system of claim 20, wherein the opioid antagonist product comprises an opioid overdose nasal spray product accessible by one or more of the users associated with the one or more communication devices.

27. The system of claim 26, wherein the nasal spray product accessible by said one or more users associated with the one or more communication devices comprises naloxone hydrochloride or a hydrate thereof.

28. The system of claim 20, wherein the opioid related condition is opioid induced respiratory depression.

29. A computer-implemented method for locating a opioid antagonist product using a mobile computing device, the mobile computing device comprising one or more processors, memory, a display, a user interface, a global positioning system (GPS) antenna, and a wireless communication antenna, the method comprising:
determining a location of the computing device based on a GPS signal received by the GPS antenna;
receiving, via the user interface, an input from a user indicative of an opioid related condition;
in response to receiving the input indicative of the opioid related condition, communicating with one or more wireless networks via the wireless communication antenna to determine nearby opioid antagonist products; and
displaying, via the device display, location(s) of the determined nearby opioid antagonist products, or transmitting an opioid related condition alert to a communication device associated with a user having access to the determined nearby opioid antagonist products.

30. The method of claim 29, wherein the determined nearby opioid antagonist products include nasal spray products adapted for treating opioid induced respiratory depression.

31. The method of claim 30, wherein the determined nearby nasal spray products include naloxone hydrochloride or a hydrate thereof.
